(19) United States
(12) Patent Application Publication
(10) Pub. No.: US 2003/0161568 A1
(43) Pub. Date: Aug. 28, 2003

(54) Apparatus and method for Polarization Mode Dispersion Compensation (PMDC) and Chromatic Dispersion Compensation (CDC)

(76) Inventors: Hatem H. El-Refaei, Ottawa (CA); Helen F. Priddle, Bishop's Stortford (GB)

Correspondence Address: DOWELL & DOWELL PC, SUITE 309, 1215 JEFFERSON DAVIS HIGHWAY, ARLINGTON, VA, 22202

(21) Appl. No.: 10/107,047

(22) Filed: Mar. 28, 2002

Related U.S. Application Data
(60) Provisional application No. 60/359,997, filed on Feb. 28, 2002.

(51) Int. Cl. G02B 6/26; G02B 6/17

(52) U.S. Cl. 385/11; 385/37; 385/27

(57) ABSTRACT

(Polarization Mode Dispersion Compensation) and CDC (Chromatic Dispersion Compensation) in an optical signal are provided. An optical signal has a first polarization and a second polarization that lags the first polarization with a DGD (Differential Group Delay), Δτ. The first and second polarizations are each aligned with a respective one of slow and fast principal axes of a PM (Polarization Maintaining) fiber having a chirped grating. The first and second polarizations propagate through the PM fiber and are reflected at two different points along the PM fiber in a manner that the first and second polarizations emerge from the PM fiber in synchronization after being reflected. In some embodiments, the optical signal then propagates through an optical fiber having a chirped grating to control dispersion.

### RELATED APPLICATIONS

This application claims the benefit of U.S. Provisional Application Serial No. ______ filed Feb. 28, 2002.

### FIELD OF THE INVENTION

The invention relates to dispersion in optical transmission systems. More particularly, invention relates to polarization mode dispersion compensation and chromatic dispersion compensation.

### BACKGROUND OF THE INVENTION

When an optical signal propagates through an optical transmission medium such as an optical fiber chromatic mode dispersion and polarization mode dispersion occurs over distances. More particularly, in PMD (Polarization Mode Dispersion), two polarizations of the optical signal, each aligned with one of two principal axes of polarization of the optical fiber, have different group velocities. The different group velocities of the polarizations result in a PGD (Polarization Group Delay) which, in turn, results in PMD. Some techniques have been used to perform PMDC (Polarization Group Delay Compensation) in OC192 systems by controlling the polarizations using an external polarization controller and having the optical signal propagate through a fixed length of PM (Polarization Maintaining) fiber. The external polarization controller manipulates the two polarizations of the optical signal in a manner that one of the two polarizations having a faster group velocity is rotated parallel to a slow principal axis of the PM fiber and that the other one of the two polarizations having a slower group velocity is rotated parallel to a fast principal axis of the PM fiber resulting in a reduction in the DUD and mitigation of the PMD as the optical signal propagates through the PM fiber. Since the PM fiber has a fixed length, the reduction in the DGD is constant. As such, when DGD of the optical signal, at an input of the polarization converter, varies in time, the PM fiber can only partially compensate for the DGD. Therefore, the PM fiber can only partially compensate for PMD.

### SUMMARY OF THE INVENTION

Methods and Apparatuses for Performing PMDC

(Polarization Mode Dispersion Compensation) and CDC (Chromatic Dispersion Compensation) are provided. An optical signal has a first polarization arid a second polarization that lags the first polarization with a DGD (Differential Group Delay), Δτ, resulting in PMD (Polarization Mode Dispersion). Furthermore, in some cases the optical signal is dispersive resulting in CD (Chromatic Dispersion). The PMD and the CD degrade the quality of the optical signal and limit the distance at which the signal can propagate before having to be regenerated.

The first and second polarizations are each aligned with a respective one of a slow principal axis and a fast principal axis of a birefringent wave-guide with chirped grating. The birefringent wave-guide may be a PM (Polarization Maintaining) fiber. The first and second polarizations enter the birefringent wave-guide sequentially in time and are reflected at different points along the birefringent wave-guide due to coupling with the chirped grating. An additional DGD, Δτ′, is introduced in the birefringent wave-guide with grating due to different group velocities of the first and second polarizations and due to different distances traveled by the first and second polarizations in the birefringent wave-guide with chirped grating. The additional DGD, Δτ′, offsets the DGD, Δτ, so that the first and second polarizations emerge from the birefringent wave-guide with chirped grating in synchronization with a total DGD, Δτ₁=Δτ+Δτ′=0. This results in PMDC, In cases where the optical signal is dispersive, the optical signal then propagates through an optical wave-guide with chirped grating. In such a case, a continuous range of wavelengths, λⱼ, enter the optical wave-guide sequentially in time and are reflected, due to coupling with the chirped grating, at different points along the optical wave-guide in a manner that the wavelengths, λⱼ, emerge from the optical wave-guide in synchronization. This results in CDC.

Embodiments of the invention are not limited to the speed of transmission, however, they are particularly useful for optical systems transmitting information at 40 Gbps and beyond where PMD and CD can both restrict the length over which a signal can be transmitted before having to be regenerated. Therefore, embodiments of the invention enable PMDC and CDC in long fiber transmission links for high-speed optical transmission. Providing PMDC and CDC in such links reduces the number of required regeneration sites and therefore reduces link costs.

In accordance with a first broad aspect of the invention, provided is a an optical apparatus. The apparatus has a birefringent wave-guide which is used to receive an optical signal having a first polarization and a second polarization. The birefringent wave-guide may be a birefringent planar wave-guide or may be a PM fiber. The apparatus is also used to allow the first polarization and the second polarization to propagate at different group velocities, The birefringent wave-guide has a chirped grating which is used to reflect the first polarization and the second polarization at different points along the birefringent wave-guide.

In accordance with another embodiment of the invention, provided is an optical apparatus adapted to perform PMDC. The apparatus has a birefringent wave-guide comprising a fast principal axis, a slow principal axis and a chirped grating. The apparatus also has a PC (Polarization Controller) connected to the birefringent wave-guide. The PC receives an optical signal and aligns a first polarization to one of the slow and fast principal axes. The PC also aligns a second polarization to another one of the slow and fast principal axes, wherein the second polarization lags the first polarization with a DGD, Δτ. The first and second polarizations are each aligned with a respective one of the slow and fast principal axes so that they will propagate at different group velocities through the birefringent wave-guide and be reflected, through coupling with the chirped grating, at different points along the birefringent wave-guide. The different group velocities and reflection at the different points result in the first polarization undergoing a greater time delay in the birefringent wave-guide when compared to a time delay, in the birefringent wave-guide, of the second polarization.

In some embodiments of the invention, the birefringent wave-guide is a PM fiber.

In some embodiments the optical apparatus may have an optical circulator connected between the PC and an input. The optical circulator may be a 3-port optical circulator and it may be used to re-direct the optical signal propagating from the input into the PC anti re-direct the optical signal propagating from the PC to an output. Furthermore, in some embodiments, the optical circulator may be a chip optical ciculator.

The optical apparatus may be adapted to perform PMDC and CDC of a dispersive optical signal having wavelengths, λⱼ, and an average DGD, <Δτ>. Such an apparatus may have an optical wave-guide with a chirped grating connected to the optical circulator. The optical wave-guide may be an optical fiber or any suitable optically transmitting material capable of performing wave-guide functionality. Furthermore the optical wave-guide may be integrated on a chip. The optical wave-guide may be used to receive the dispersive optical signal and reflect the wavelengths, λⱼ, at different points along the optical wave-guide in a manner that the wavelengths, λⱼ, emerge from the optical wave-guide in synchronization.

In accordance with another embodiment of the invention, provided is an optical apparatus used to perform PMDC. The apparatus has a birefringent wave-guide comprising a fast principal axis, a slow principal axis and a chirped grating. The apparatus also has an optical circulator and a PC. The PC is connected to the birefringent wave-guide, through the optical circulator. The PC is used to receive an optical signal and align a first polarization with one of the slow and fast principal axes. The PC also aligns a second polarization, which lags the first polarization with a DGD Δτ, to another one of the slow and fast principal axes. The first and second polarizations are aligned so that they propagate at different group velocities through the birefringent wave-guide and are reflected, through coupling with the chirped grating, at different points along the birefringent wave-guide. This results in the first polarization undergoing a greater time delay in the birefringent wave-guide when compared to a time delay, in the birefringent wave-guide, of the second polarization.

The birefringent wave-guide may be a PM fiber or any suitable birefringent material capable of transmitting the optical signal and capable of performing wave-guide functionality. The birefringent wave-guide may also be integrated on a chip.

The chirped grating may have a spatial period, Λ, that varies linearly or non-linearly along the length of the birefringent wave-guide. More particularly, in some embodiments the spatial period, Λ, may vary quadratically.

The birefringent wave-guide may be embedded in a piezo-electric device which may be used to stretch the birefringent wave-guide to control the spatial period, Λ, of the chirped grating. An optical tap may be connected to the optical circulator at an output to re-direct a minor portion of the optical signal to a control circuit. The control circuit may be used to detect a total DGD, Δτ₁=Δτ+Δτ′, of the first and second polarization from the minor portion of the optical signal, wherein Δτ′ is a DGD introduced in the birefringent wave-guide. The control circuit may provide instructions to the piezo-electric device for tuning the spatial period, Λ, of the chirped grating based on the total DGD, Δτ₁. The control circuit may also be used to measure a polarization state of the minor portion of the optical signal and provide instructions to the PC for tuning an alignment of the first and second polarizations with a respective one of the slow and fast principal axes of the birefringent wave-guide, based on the polarization state. In other embodiments of the invention, the birefringent wave-guide may be embedded in one or more heaters. The heaters may be used to control effective indexes of refraction, n_{s,eff}, n_{f,eff}, of the slow and fast principal axes, respectively. Furthermore, the control Circuit may provide instructions to the heaters for tuning the effective indexes of refraction, n_{s,eff}, n_{j,eff}, based on the total DGD, Δτ₁.

In some embodiments another birefringent wave-guide may be used to connect the optical circulator and the PC. Furthermore, the optical circulator may be a 3-port optical circulator.

An optical wave-guide having a chirped grating may also be connected to the optical circulator so that the optical apparatus may perform CDC in addition to PMDC. The optical wave-guide may be an optical fiber or any suitable material capable of transmitting light and performing wave-guide functionality. Furthermore, the optical wave-guide may be integrated on a chip. The optical apparatus may be applied to a dispersive optical signal having wavelengths, λⱼ, and an average DGD, <Δτ>. After the dispersive optical signal has undergone PMDC, the optical wave-guide may be used to receive the dispersive optical signal and reflect the wavelengths, λⱼ, at different points along the optical wave-guide in a manner that the wavelengths, λⱼ, emerge from the optical wave-guide in synchronization. In such embodiments, the optical circulator may be a 4-port optical circulator. Furthermore, the optical apparatus may have control means for tuning a dispersion of the optical signal detected at an output. More particularly, the optical wave-guide may be embedded in a piezo-electric device. The control circuit may detect a dispersion of a minor portion of the dispersive optical signal, at an output. The control circuit may then provided instructions to the piezo-electric device, in which the optical wave-guide is embedded, for tuning a spatial period, Λ′, of the optical wave-guide, based on the dispersion, by applying a tensile force upon the optical wave-guide and stretch the optical wave-guide. In other embodiments of the invention, the optical wave-guide may be embedded in one or more heaters and the control circuit may provide instructions to the heaters for applying heat to the optical wave-guide, based on the dispersion, to tune an effective index of refraction n′_{eff} of the optical wave-guide and control the dispersion.

The functionality of the birefringent wave-guide, the optical wave-guide, the PC, the control circuit and the optical tap may be integrated on a chip. Furthermore, the PMD compensator and the PMD and CD compensator may be implemented in any optical transmission system.

In accordance with another embodiment of the invention, provided is a method of performing PMDC upon an optical signal having a first polarization and a second polarization. The second polarization lags the first polarization with a DGD, Δτ. The first polarization is aligned with one of a slow principal axis and a fast principal axis of a birefringent wave-guide having a chirped grating and the second polarization is aligned with another one of the slow and fast principal axes of the birefringent wave-guide. The first and second polarizations are then propagated through the birefringent wave-guide at different group velocities and reflected at different points along the birefringent wave-guide. The first polarization and the second polarization are each aligned with a respective one of the slow and fast principal axes in a manner that the first polarization undergoes a greater time delay in the birefringent wave-guide when compared to a time delay, in the birefringent wave-guide, of the second polarization.

The method may be used to perform CDC in addition to PMDC, In such a method a dispersive optical signal has wavelengths, λⱼ, and an average DGD, <Δτ>. After the dispersive optical signal has undergone PMDC, the first and second polarizations are propagated through an optical wave-guide with the wavelengths, λⱼ, entering the optical wave-guide sequentially in time. In the optical wave-guide, the wavelengths, λⱼ, are reflected at different points along the optical wave-guide in a manner that the wavelengths, λⱼ, emerge from the optical wave-guide in synchronization after being reflected.

### BRIEF DESCRIPTION OF THE DRAWINGS

Preferred embodiments of the invention will now be described with reference to the attached drawings in which:

FIG. 1A is a schematic block diagram of a PMD (Polarization Mode Dispersion) compensator, in an embodiment of the invention;

FIG. 1B is a side view of a PM fiber with grating of the PMD compensator of FIG. 1A;

FIG. 2 is a schematic block diagram of a PMD compensator, in another embodiment of the invention;

FIG. 3 is a schematic block diagram of a PMD compensator, in another embodiment of the invention;

FIG. 4 is a schematic block diagram of a PMD compensator, in another embodiment of the invention;

FIG. 5 is a schematic block diagram of a PMD and CD (Chromatic Dispersion) compensator, in another embodiment of the invention;

FIG. 6 is a schematic block diagram of a PMD and CD compensator, in another embodiment of the invention;

FIG. 7 is a schematic block diagram of a PMD and CD compensator, in another embodiment of the invention;

FIG. 8 is a schematic block diagram of a PMD and CD compensator, in another embodiment of the intention; and

FIG. 9 is a schematic block diagram of a PMD and CD compensator, in yet another embodiment of the invention.

### DETAILED DESCRIPTION OF THE PREFERRED EMBODIMENTS

In optical systems, optical fibers used as transmission media have imperfections such as geometrical asymmetries, doping asymmetries, asymmetrical stress and environmental variations. These imperfections result in the optical fibers having a fast and a slow principal axis of polarization. When an optical signal propagates through such optical fibers a component (referred to as a fast principal state of polarization) of the optical signal propagating along the fast principal axis has a faster group velocity than that of a component (refereed to as a slow principal state of polarization) of the optical signal propagating along the slow principal axis. As the optical signal propagates through the optical fiber the difference in group velocities causes a DGD (Differential Group Delay) between the fast and the slow principal states of polarization wherein signal propagation with the slow principal state of polarization lags behind signal propagation with the fast principal state of polarization. The DGD is typically measured in picoseconds. In an optical fiber, the direction of the fast and the slow principal axes changes along the length of the optical fiber depending on the imperfections. This results in a DGD that develops over distances. Furthermore, a dispersive optical signal having a continuous range of wavelengths, λⱼ, has a DGD associated with each one of the wavelengths, λⱼ, resulting in an average DGD, <Δτ>which follows a Maxwellian distribution as a function of distance of propagation. More particularly, the average DGD <Δτ>∝\sqrt{d} where d is the distance travelled by the dispersive optical signal through the optical fiber. The average DGD develops over distances of propagation and results in PMD (Polarization Mode Dispersion). The PMD degrades the quality of the optical signal. This effect is present at all transmission speeds however it is of particular importance in optical systems of high bit-rate where the bit rate is as high as 40 Gps.

Dispersion effects are also important in optical transmission systems. In dispersive media such as an optical fiber, the group velocity of an optical signal propagating through the optical fiber depends on wavelength within a channel bandwidth of the optical signal. Optical wavelengths within a channel bandwidth travel with different group velocities and this results in pulse broadening during propagation through the optical fiber. This pulse broadening results in inter-bit interference and in an increase in a BER (Bit Error Rate). The increased BER, in turn, limits the distance at which the optical signal can propagate through the optical fiber before having to be regenerated.

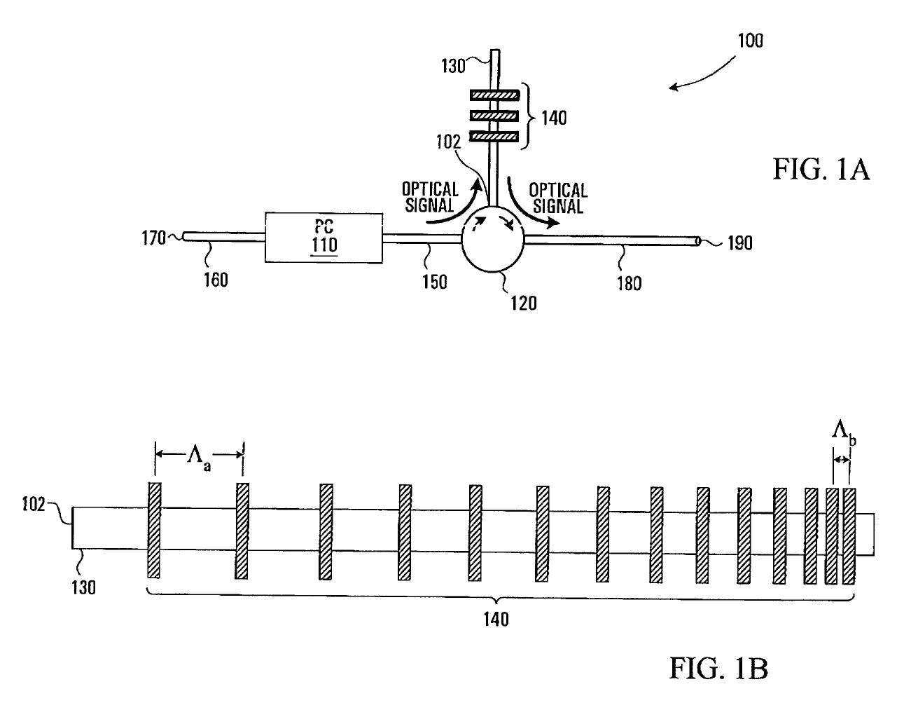

Referring to FIG. 1A, shown is a schematic block diagram of a PMD compensator 100, in an embodiment of the invention. The PMD compensator 100 has a PC (Polarization Controller) 110, a 3-port optical circulator 120 and a PM (Polarization Maintaining) fiber 130 with a chirped grating 140. The PC 110 is connected to the PM fiber 130 through another PM fiber 150 and the 3-port optical circulator 120. More particularly, an end 102 of the PM fiber 130 is connected to the 3-port optical circulator 120. The two PM fibers 130, 150 are aligned so that respective fast principal axes of the two PM fibers 130, 150 are aligned and so that respective slow principal axes of the two PM fibers 130, 150 are aligned. An optical fiber 160 is connected to the PC 110 and forms an input 170. An optical fiber 180 is connected to the PC 110 and forms an output 190.

The chirped grating 140 has a negative chirp in which a spatial period, Λ, decreases from the end 102 along its length from Λₐ down to Λ_{b}, as shown in FIG. 1B. More particularly, the spatial period, Λ, decreases quadratically along the length of the PM fiber 130. In some embodiments of the invention, the chirped grating 140 of the PM fiber 130 is formed by irradiating the PM fiber 130 with, for example, radiation at 244 nm through a phase mask which forms fringes within a core of the PM fiber 130. This modifies a refractive index in the core by an amount that depends on the flux incident on the PM fiber 130. Modification of the refractive index in the core is caused by one of at least two mechanisms. In one embodiment of the invention, the PM fiber 130 is made of glass and is intrinsically photosensitive due to dopant, such as for example germanium or boron, incorporated within the glass. In another embodiment of the invention, the PM fiber 130 is sensitized to make it photosensitive. More particularly, for example, the PM fiber 130 is hydrogenated by being left in a vessel of high pressure hydrogen for a period of time on the order of days to weeks. This allows the hydrogen to diffuse in the core of the PM fiber 130 making it photosensitive.

An optical signal of wavelength, λ, and having a first polarization corresponding a fast principal state of polarization) and a second polarization (corresponding a slow principal state of polarization) propagates through the optical fiber 160, at the input 170, and into the PC 110. The first and second polarizations have a DGD, Δτ, with the second polarization lagging behind the first polarization. The PC 110 aligns the first and the second polarization with the slow and fast principal axes, respectively, of the PM fibers 130, 150. The optical signal propagates through the PM fiber 150 to the 3-port optical circulator 120. In the preferred embodiment of the invention, the PM fiber 150 is located between the PC and the 3-port optical circulator and is short enough so that any DGD produced in the FM fiber 150 is negligible. However, embodiments of the invention are not limited to a short PM fiber 150. The 3-port optical circulator 120 re-directs the optical signal into the PM fiber 130. The optical signal propagates a distance through the PM fiber 130 before being reflected due to coupling with the chirped grating 140. More particularly, the first and second polarizations enter the PM fiber 130 with a DGD, Δτ, wherein the first polarization enters before the second polarization. The first and second polarizations each propagate a respective distance through the PM fiber 130 before being reflected through coupling with the chirped grating 140. In the PM fiber 130, the first polarization is aligned with the slow principal axis of the PM fiber 130 whereas the second polarization is aligned with the fast axis of the PM fiber 130. The first polarization and the second polarization therefore have different group velocities and this introduces a DGD. Furthermore, the first polarization and the second polarization are reflected at different points along the length of the PM fiber 130 and this also introduces a DGD. The sum of DGDs introduced in the PM fiber 130 is Δτ′ and therefore the optical signal emerges from the PM fiber 130 with a total DGD, Δτ₁=Δτ+Δτ′. More particularly, in the embodiment of FIG. 1A, the first and second polarizations propagate through the PM fiber 130 in a manner that the first polarization undergoes a greater time delay in the PM fiber 130 when compared to a time delay, in the PM fiber 130, of the second polarization. The sum of DGDs Δτ′ introduced in the PM fiber 130 is such that Δτ=−Δτ′, and therefore the optical signal emerges from the PM fiber 130 with the first and second polarizations being Synchronized with a total DGD, Δτ₁=Δτ+Δτ′=0. The optical signal is then re-directed, by the 3-port optical circulator 120, to the output 190 through the optical fiber 180.

As discussed above, a DGD is introduced in the PM fiber 130 due to the first and second polarizations being reflected at different points along the PM fiber 130. More particularly, the PM fiber 130 reflects the first and second polarizations of wavelength, λ, at two different points along its length where the spatial period, Λ, satisfies a Bragg condition. The first polarization is aligned with the slow principal axis and the Bragg condition is given by Λ=Λ₁=λ/(2n_{s,eff}) where n_{s,eff} is an effective index of refraction of the PM fiber 130 along the slow principal axis. However, the second polarization is aligned with the fast principal axis and the Bragg condition is given by Λ=Λ₂=λ/(2n_{f,eff}) where n_{f,eff} is an effective index of refraction of the PM fiber 130 along the fast principal axis. n_{s,eff}>n_{f,eff} and therefore Λ₁<Λ₂. This results in the first and second polarizations being reflected at different points along the PM fiber 130. Furthermore, since the spatial period decreases with distance from the end 102 of the PM fiber 130, which is connected to the 3-port optical circulator 120, the first polarization propagates further into the PM fiber 130 than the first polarization.

Embodiments of the invention are not limited to cases in which the PM fiber 130 has a negative chirp. In other embodiments of the invention the PM fiber 130 has a positive chirp in which the spatial period, Λ, increases from the end 102 gradually along the length of the PM fiber 130. Furthermore, embodiments of the invention are not limited to a quadratic chirp and in other embodiments of the invention the PM fiber 130 has a linear or non-linear chirp. However, in embodiments of the invention wherein the PM fiber 130 has negative linear chirp, the first and second polarizations are aligned with the slow and fast principal axes, respectively, of the PM fiber 130, whereas, in embodiments of the invention wherein the PM fiber 130 has positive linear chirp, the first and second polarizations are aligned with the fast and slow principal axes, respectively, of the PM fiber 130.

In the above example, the optical signal is a monochromatic optical signal of wavelength, λ. However, the chirped grating 140 allows for a continuous range of wavelengths, λⱼ wherein λ_{b}≦λ≦λₐ, to be reflected and embodiments of the invention are not limited to performing PMD compensation of monochromatic signals. In other embodiments of the invention, the PM fiber 130 is used to perform PMDC for an optical signal having dispersion wherein the optical signal has a continuous range of wavelengths, λⱼ, centered about a center wavelength. In such embodiments, respective first and second polarizations of the wavelengths, λⱼ, have respective DGDs which may be different from one another resulting in a DGD, Δτ, given by Δτ=<Δτ> where <Δτ> is an average DGD. In such cases, the PM fiber 130 is tuned to introduce a DGD Δτ′, given by Δτ′=<Δτ′> where <Δτ′> an average DGD, so that PMD compensation is produced resulting in a total DGD, Δτ₁=<Δτ₁>=<Δτ>+<Δτ′>=0 where <Δτ₁> is a total average DGD. A method for tuning the FM fiber 130 will now be described.

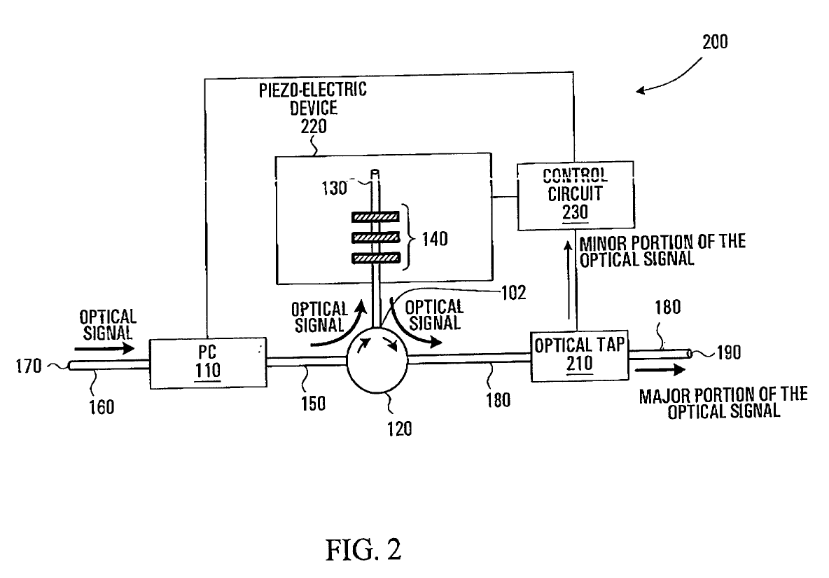

Referring to FIG. 2, shown is a schematic block diagram of a PMD compensator 200, in another embodiment of the invention. The PMD compensator 200 of FIG. 2 is similar to the PMDC 100 of FIG. 1 except that in FIG. 2 the PMDC 200 has an optical tap 210 connected to the 3-port optical circulator 120, a piezo-electric device 220, in which the PM fiber 130 is embedded, and a control circuit 230 connected to the PC 110, to the optical tap 210 and to the piezo-electric device 220. An optical signal, at the input 170, has a first polarization and a second polarization lagging the first polarization. After having propagated through the PC 110, the 3-port optical circulator 120, the FM fiber 130 and back through the 3-port optical circulator 120, the optical signal propagates through the optical tap 210. A major portion of the optical signal is then output to the output 190 through the optical fiber 180 and a minor portion of the optical signal propagates to the control circuit 230. The control circuit 230 detects the minor portion of the optical signal. The control circuit 230 measures a polarization state of the minor portion of the optical signal and the total DGD, Δτ₁, of the first and second polarizations from the minor portion of the optical signal. The control circuit 230 then provides instructions to the PC 110 for controlling the alignment of the first and second polarizations with the slow and fast axes, respectively, of the PM fiber 130 based on information on the polarization state. The control circuit 230 also provides instructions to the piezo-electric device for applying a tensile force to stretch the PM fiber 130, based on information on the total DGD, Δτ₁. By stretching the PM fiber 130, the piezo-electric device 220 controls the spatial period, Λ, of the chirped grating 140 in a manner that allows the point at which the optical signal is reflected to be controlled. In other embodiments of the invention, the piezo-electric device 220 is replaced by one or more heaters. In such embodiments of the invention, the heaters control n_{s,eff} and n_{f,eff} in a manner that allows the point at which the optical signal is reflected in the PM fiber 130 to be controlled. Possible tuning mechanisms for the PM fiber 130 include, but are not limited to heating and to stretching using a piezo-electric device.

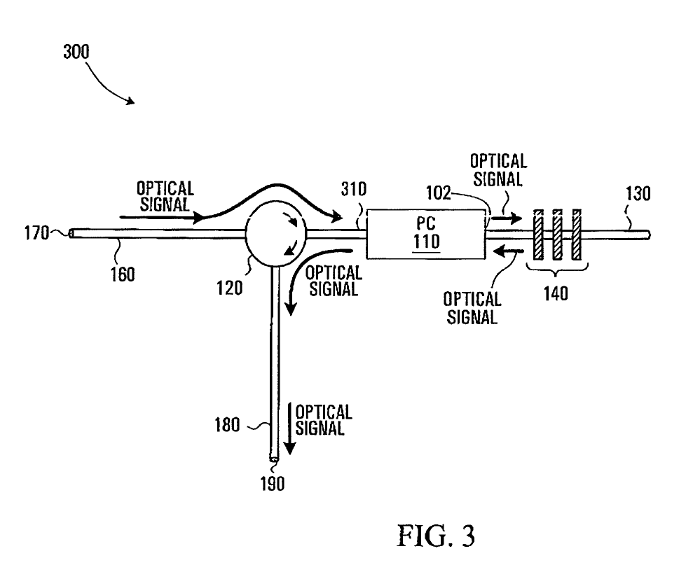

Referring to FIG. 3, shown is a schematic block diagram of a PMD compensator 300, in another embodiment of the invention. The PMD compensator 300 includes the PC 110, the 3-port optical circulator 120 and the PM fiber 130 having the chirped grating 140. The PC 110 is connected to the PM fiber 330. The PC 110 is also connected to the 3-port optical circulator 120 through an optical fiber 310.

An optical signal, at the input 170, has a first polarization and a second polarization lagging the first polarization with a DGD, Δτ. The optical signal propagates through the optical fiber 160, at the input 170, and into the 3-port optical circulator 120 where it is re-directed into the PC 110. The PC 110 aligns the first and second polarizations with the slow and fast principal axes of the PM fiber 130, respectively. The optical signal then propagates into the PM fiber 130 where it is reflected and undergoes PMD compensation. The optical signal then propagates back into the PC 110 to the 3-port optical circulator 120 where it is re-directed into the optical fiber 180 at the output 190.

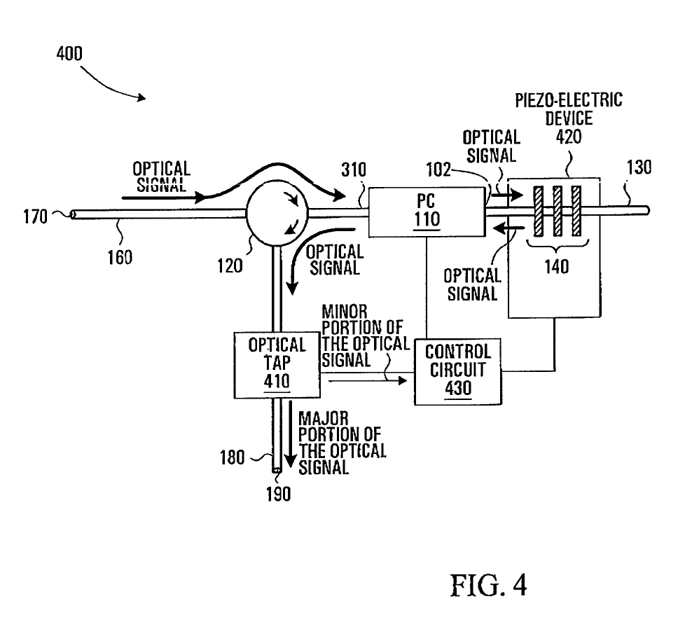

Referring to FIG. 4, shown is a schematic block diagram of a PMD compensator 400, in another embodiment of the invention. The PMD compensator 400 of FIG. 4 is similar to the PMD compensator 300 of FIG. 3 except that in FIG. 4 the PMD compensator 400 has an optical tap 410 connected to the 3-port optical circulator 120, a piezo-electric device 420, in which the PM fiber 130 is embedded, and a control circuit 430. The control circuit 430 is connected to the optical tap 410, to the piezo-electric device 420 and to the PC 110. After undergoing PMDC through the PM fiber 130 an optical signal propagates back through the PC 110, into the optical circulator 120 and into the optical tap 410. A major portion of the optical signal is then output through the optical fiber 180 to the output 190 and a minor portion of the optical signal propagates to the control circuit 430. The control circuit 430 detects the minor portion of the optical signal. The control circuit 430 also measures a polarization state of the minor portion of the optical signal and measures the total DGD, Δτ₁, of the first and second polarizations from the minor portion of the optical signal. The control circuit 430 then provides instructions to the PC 110 for controlling the alignment of the first and second polarizations with the slow and fast axes, respectively, of the PM fiber 130 based on information on the polarization state. The control circuit 430 also provides instructions to the piezo-electric device 420 for applying a tensile force to stretch the PM fiber 130, based on information on the total DGD, Δτ₁. In other embodiments of the invention, the piezo-electric device 420 is replaced by one or more heaters. Possible tuning mechanisms for the PM fiber 130 include, but are not limited to heating and to stretching using a piezo-electric device.

The PMD compensators 100, 200, 300, 400 of FIGS. 1A and 2 to 4 are used to perform PMDC of monochromatic and dispersive optical signals. For a dispersive optical signal of wavelengths, λⱼ, the points at which first and second polarizations of the wavelengths, λⱼ, are reflected depend on the Bragg condition which, in turn, depends on the wavelengths, λⱼ. The PM fiber 130 therefore changes the dispersion of the dispersive optical signal. Consequently, in some embodiments of the invention, one of a positive chirp and a negative chirp which results in a decrease in the dispersion of the dispersive optical signal is used to perform partial CDC (Chromatic Dispersion Compensation) Furthermore, in some embodiments of the invention, an optical fiber with a chirped grating is combined with any one of the PMD compensators 100, 200, 300, 400 of FIGS. 1A and 2 to 4 to perform further CDC of the dispersive optical signal in addition to performing PMDC.

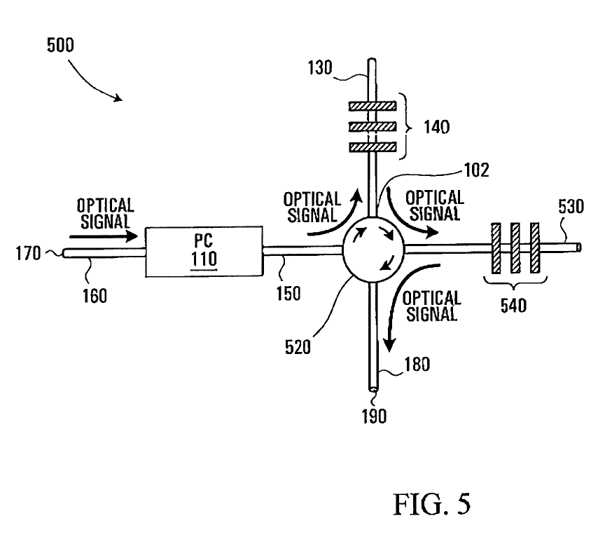

Referring to FIG. 5, shown is a schematic block diagram of a PMD and CD compensator 500, in another embodiment of the invention. The PMD and CD compensator 500 includes the PC 110, a 4-port optical circulator 520, the PM fiber 130 with the chirped grating 140, and an optical fiber 530 with a chirped grating 540. The PC 110 is connected to the PM fiber 130 through the PM fiber 150 and the 4-port optical circulator 520. The PM fibers 130, 150 are aligned so that the respective fast principal axes of the two PM fibers 130, 150 are aligned and so that the respective slow principal axes of the two PM fibers 130, 150 are aligned. The optical fiber 530 is connected to the 4-port optical circulator 520.

At the input 170, an optical signal has PMD and CD. More particularly, the optical signal is dispersive having continuous range of wavelengths, λⱼ, wherein λ_{b}≦λⱼ≦λₐ with each wavelength having a first polarization and a second polarization lagging the first polarization resulting in a DGD, Δτ=<Δτ>. The optical signal propagates through the PC 110 and is re-directed into the PM fiber 130, through the 4-port optical circulator 520, where it is reflected. As discussed above, different group velocities and different points of reflection in the PM fiber 130 of the first and second polarizations of the wavelengths, λⱼ, result in a reduction in the DGD, Δτ=<Δτ>, thus resulting in PMD compensation. The optical signal then propagates through the 4-port optical circulator 520 where it is re-directed into the optical fiber 530. A waveform associated with the optical signal is slightly distorted due to dispersion effects and the wavelengths, λⱼ, with λ_{b}≦λⱼ≦λₐ of the optical signal enter sequentially, in time, into the optical fiber 530. Each wavelength, λⱼ, propagates respective a length into the optical fiber 530 before being reflected back into the 4-port optical circulator 520. More particularly, each one of the wavelengths, λⱼ, is reflected at a respective point along the optical fiber 530 where a spatial period, Λ′ of the chirped grating 540 satisfies Λ′=Λ′ⱼ=λⱼ/(2n′_{eff}) where Λ′ⱼ is a spatial period and n′_{eff} is an effective index of refraction of the optical fiber 530. Each one of the wavelengths, λⱼ, therefore travels through a specific optical path length that is controlled by a slope, length and non-linearity of the chirped grating 540. The wavelengths, λⱼ, each perform a round trip through the optical fiber 530 and they exit the optical fiber 530 in synchronization. The optical signal then propagates back into the 4-port optical circulator 520 where it is re-directed out into the optical fiber 180 to the output 190.

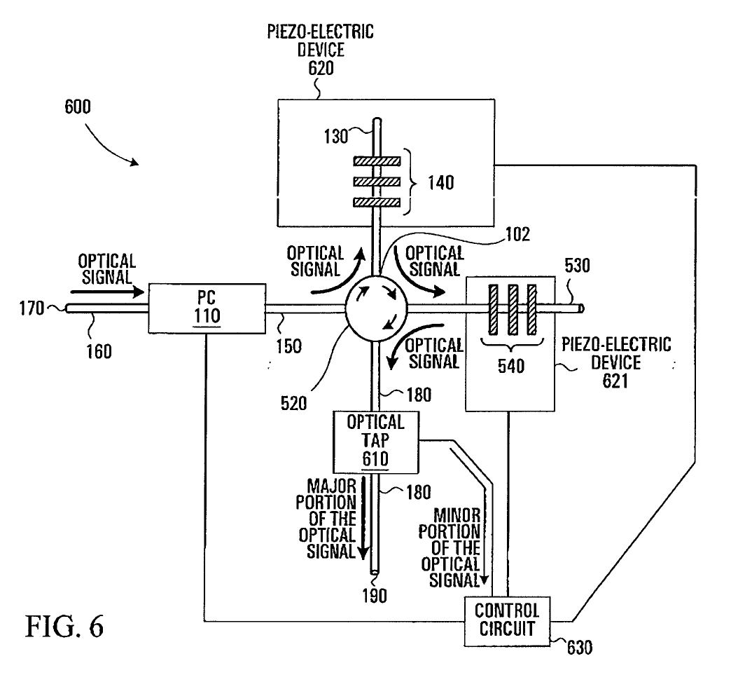

Referring to FIG. 6, shown is a schematic block diagram of a PMD and CD compensator 600, in another embodiment of the intention. The PMD and CD compensator 600 of FIG. 6 is similar to the PMD and CD compensator 500 of FIG. 5 except that in FIG. 6 the PMD and CD compensator 600 has an optical tap 610 connected to the 4-port optical circulator 520, a piezo-electric device 620 in which the PM fiber 130 is embedded, a piezo-electric device 621 in which the optical fiber 530 is embedded, and a control circuit 630. The control circuit 630 is connected to the optical tap 610, to the piezo-electric devices 620, 621 and to the PC 110. After undergoing PMDC through the PM fiber 130 and undergoing CDC through the optical fiber 530 a dispersive optical signal propagates through the 4-port optical circulator 520 and into the optical tap 610. A major portion of the optical signal is then output through the optical fiber 180 to the output 190 and a minor portion of the optical signal propagates to the control circuit 630. The control circuit 630 detects the minor portion of the optical signal. The control circuit 630 also measures the dispersion and the polarization state of the minor portion of the optical signal and measures the total average DGD, <Δτ₁>, of the first and second polarizations from the minor portion of the optical signal. The control circuit 630 then provides instructions to the PC 110 for controlling the alignment of the first and second polarizations with the slow and fast axes, respectively, of the PM fiber 130 based on information on the polarization state. The control circuit 630 provides instructions, based on information on the average total average DGD, <Δτ₁>, to the piezo-electric device 620, in which the PM fiber 130 is embedded, for stretching the PM fiber 130. The control circuit 630 also provides instructions, based on information on the dispersion, to the piezo-electric device 621, in which the optical fiber 530 is embedded, for stretching the optical fiber 530. In other embodiments of the invention, the piezo-electric device 621 is replaced by one or more heaters. In such embodiments, the heaters apply heat to the optical fiber 530, based on the dispersion, to tune the effective index of refraction n′_{eff} of the optical fiber and reduce the dispersion. Furthermore, in some embodiments of the invention, the piezo-electric device 620 is replaced by one or more heaters.

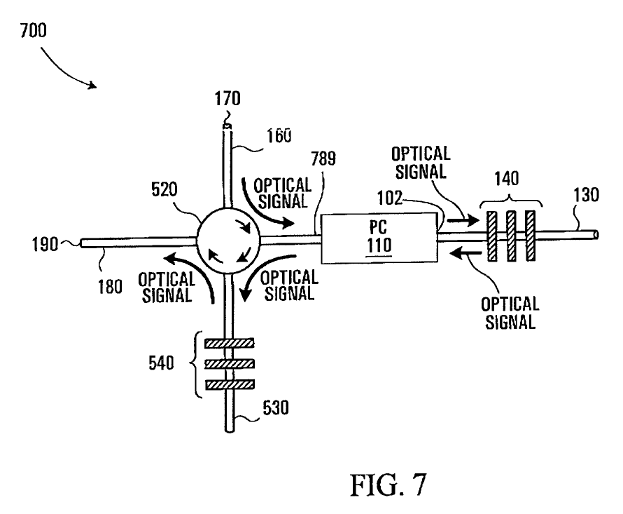

Referring to FIG. 7, shown is a schematic block diagram of a PMD and CD compensator 700, in another embodiment of the invention. The PMD and CD compensator 700 includes the PC 110, the 4-port optical circulator 520, the PM fiber 130 with the chirped grating 140 and the optical fiber 530 with the chirped grating 540. The PC 110 is connected to the PM fiber 130 and to the 4-port optical circulator 520 through an optical fiber 789 whereas thee optical fiber 530 with the chirped grating 540 is connected to the 4-port optical circulator 520. At the input 170, an optical signal has PMD and CD. More particularly, the optical signal has a continuous range of wavelengths, λⱼ, each having a first polarization and a second polarization lagging the first polarization resulting in the average DGD, <Δτ>. The PC 110 aligns the first and second polarizations with the slow and fast principal axes, respectively, of the PM fiber 130. The optical signal then propagates into the PM fiber 130 where it is reflected and undergoes PMD compensation. The optical signal then propagates back into the PC 110 to the 4-port optical circulator 520 where it is re-directed into the optical fiber 530. Within the optical fiber 530 the optical signal is reflected and undergoes CD compensation. The optical signal then emerges from the optical fiber 530 and propagates into the 4-port optical circulator 520 where it is re-directed into the optical fiber 180 to the output 190.

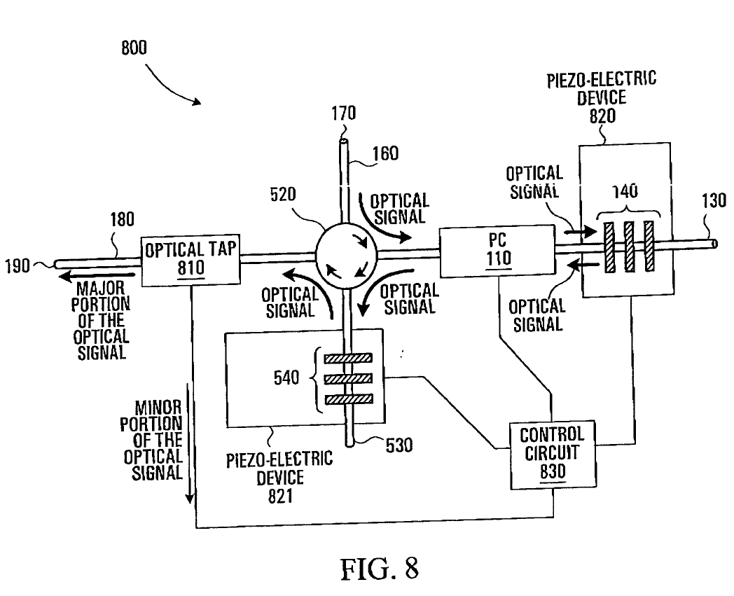

Referring to FIG. 8, shown is a schematic block diagram of a PMD and CD compensator 800, in yet another embodiment of the invention. The PMD and CD compensator 800 of FIG. 8 is similar to the PMD and CD compensator 700 of FIG. 7 except that in FIG. 8 the PMD and CD compensator 800 has an optical tap 810 connected to the 4-port optical circulator 520, a piezo-electric device 820 in which the PM fiber 130 is embedded, a piezo-electric device 821 in which the optical fiber 530 is embedded, and a control circuit 830. The control circuit 830 is connected to the optical tap 810, to the piezo-electric devices 820, 821 and to the PC 110. After undergoing CDC through the optical fiber 130 a dispersive optical signal propagates through the 4-port optical circulator 520 and into the optical tap 810. A major portion of the optical signal is then output through the optical fiber 180 to the output 190 and a minor portion of the optical signal propagates to the control circuit 830. The control circuit 830 detects the minor portion of the optical signal. The control circuit 830 also measures the dispersion and the polarization state of the minor portion of the optical signal and measures the total average DGD, <Δτ₁>, of the first and second polarizations from the minor portion of the optical signal. The control circuit 830 then provides instructions to the PC 110 for controlling the alignment of the first and second polarizations with the slow and fast axes, respectively, of the PM fiber 130 based on information on the polarization state. The control circuit 830 provides instructions, based on information on the total average DGD, <Δτ₁>, to the piezo-electric device 820, in which the PM fiber 130 is embedded, for stretching the PM fiber 130. The control circuit 830 also provides instructions, based on information on the dispersion, to the piezo-electric device 821, in which the optical fiber 530 is embedded, for stretching the optical fiber 530. In other embodiments of the invention, at least one of the piezo-electric devices 820, 821 are replaced by one or more heaters.

In effect, the control circuit 830, the piezo-electric devices 820, 821 and the optical tap 810, in conjunction with the PC 110, the PM fiber 130 and the optical fiber 530, form a control system for controlling alignment of the first and second polarization and controlling the dispersion.

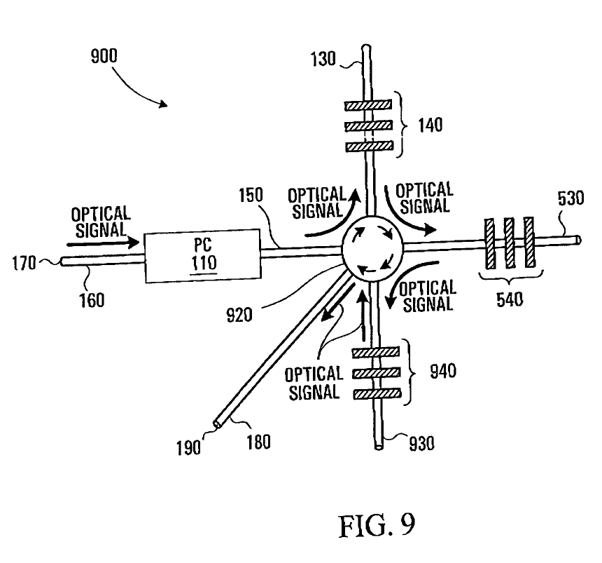

Referring to FIG. 9, shown is a schematic block diagram of a PMD and CD compensator 900, in yet another embodiment of the invention. The PMD and CD compensator 900 of FIG. 9 is similar to the PMD and CD compensator 500 of FIG. 5 except that the 4-port optical circulator 520 of FIG. 5 is replaced with a 5-port optical circulator 920 and another optical fiber 930 with a chirped grating 940 is connected to the 5-port optical circulator 920. In such an embodiment, an optical signal undergoes CDC in both optical fibers 530, 930. More particularly, one of the chirped gratings 540, 940 is a positive chirped grating and the other one is a negative chirped grating. A combination of a positive and a negative chirp allows the optical fibers 530, 930 to collectively prevent introduction of second order chromatic dispersion effects during DCD.

In some embodiments of the invention the PMD and CD compensator 900 is equipped with a control system, as discussed above with reference to FIG. 8, for controlling alignment of the first and second polarization and controlling the dispersion.

Embodiments of FIGS. 1 to 9, are shown with the PM fibers 130, 150 and optical fibers 530, 930, 160, 180. However, embodiments of the invention are not limited to PM fibers and optical fibers. In other embodiments the invention, the optical fibers 530, 930, 160, 180 are optical wave-guides made of any suitable material capable of transmitting light and capable of performing wave-guide functionality. More particularly, in sore embodiments, the optical wave-guides are optical planar wave-guides. Furthermore, in some embodiments of the invention, the PM fibers 130, 150 are made of any suitable birefringent material, having a slow principal axis with index of refraction, n_{s,eff} and a fast principal axis with index of refraction, n_{f,eff}, capable of transmitting light and capable of performing wave-guide functionality. Such a birefringent material is referred to as a birefringent wave-guide. More particularly, in some embodiments, the birefringent wave-guides are birefringent planar wave-guides. Note that PM fibers and optical fibers form subsets of wave-guides.

A chirped grating is impressed on to the wave-guides using any one of the methods discussed above with regards to the PM fiber 130 of FIG. 1. Furthermore, in some embodiments of the invention, a chirped grating is impressed on to the wave-guides by etching the wave-guides with the spatial period, Λ.

In some embodiments the wave-guides are integrated on a chip. Furthermore in some embodiments, the optical circulators 120, 520, 920 of FIGS. 1 to 9 are also integrated on an chip. Finally, in some embodiments, functions of the optical taps 21 0, 410, 610, 810 and the control circuits 230, 430, 630, 830 of FIGS. 2, 4, 6 and 8, respectively are also integrated on a chip,

Numerous modifications and variations of the present invention are possible in light of the above teachings. It is therefore to be understood that within the scope of the appended claims, the invention may be practiced otherwise than as specifically described herein.

We claim:

1. An optical apparatus comprising:
a birefringent wave-guide adapted to receive an optical signal having a first polarization and a second polarization and adapted to allow the first polarization and the second polarization to propagate at different group velocities, the birefringent wave-guide comprising:
a chirped grating adapted to reflect the first polarization and the second polarization at different points along the birefringent wave-guide.

2. An optical apparatus according to claim 1 wherein the birefringent wave-guide is a birefringent planar wave-guide.

3. An optical apparatus according to claim 1 wherein the birefringent wave-guide is a PM (Polarization Maintaining) fiber.

4. An optical apparatus adapted to perform PMDC (Polarization Mode Dispersion Compensation), the apparatus comprising:
a birefringent wave-guide comprising a fast principal axis, a slow principal axis and a chirped grating; and
a PC (Polarization Controller) connected to the birefringent wave-guide and adapted to receive an optical signal having a first polarization and a second polarization that lags the first polarization with a DGD (Differential Group Delay), Δτ, the PC also being adapted to align the first polarization with one of the slow principal axis and the fast principal axis and to align the second polarization with another one of the slow principal axis and the fast principal axis, so that the first polarization and the second polarization propagate at different group velocities through the birefringent wave-guide and are reflected, through coupling with the chirped grating, at different points along the birefringent wave-guide resulting in the first polarization undergoing a greater time delay in the birefringent wave-guide when compared to a time delay, in the birefringent wave-guide, of the second polarization.

5. An optical apparatus according to claim 4 wherein the birefringent wave-guide is a planar wave-guide.

6. An optical apparatus according to claim 4 wherein the birefringent wave-guide is a PM fiber.

7. An optical apparatus according to claim 4 comprising an optical circulatory connected to the PC and adapted to re-direct the optical signal propagating from an input into the PC and re-direct the optical signal propagating from the PC to an output.

8. An optical apparatus according to claim 7 comprising means for tuning a total DGD, Δτ₁=Δτ+Δτ′, at the output, wherein Δτ′ is a DGD introduced in the birefringent wave-guide.

9. An optical apparatus according to claim 4 wherein the birefringent wave-guide is adapted to perform PMDC and CDC (Chromatic Dispersion Compensation) of a dispersive optical signal having wavelengths, λⱼ, and an average DGD, <Δτ>.

10. An optical apparatus according to claim 7 adapted to perform PMDC and CDC of a dispersive optical signal having wavelengths, λⱼ, and an average DGO, <Δτ>, the apparatus comprising an optical wave-guide having a chirped grating connected to the optical circulator, the optical wave-guide being adapted to receive the dispersive optical signal and reflect the wavelengths, λⱼ, at different points along the optical wave-guide in a manner that the wavelengths, λⱼ, emerge from the optical wave-guide in synchronization.

11. An optical apparatus according to claim 10 wherein the optical wave-guide is an optical fiber.

12. An optical apparatus according to claim 10 comprising control means for tuning a total average DGD, <Δτ₁>=<Δτ>+<Δτ′>, of the dispersive optical signal, detected at the output, wherein <Δτ′> is an average DGD introduced in the birefringent wave-guide.

13. An optical apparatus according to claim 10 comprising control means for tuning the dispersion of the dispersive optical signal detected at the output.

14. An optical apparatus adapted to perform PMDC, the apparatus comprising;
a birefringent wave-guide comprising a fast principal axis, a slow principal axis and a chirped grazing;
an optical circulator; and
a PC connected to the birefringent wave-guide, through the optical circulator, and adapted to receive an optical signal having a first polarization and a second polarization that lags the first polarization with a DGD, Δτ, the PC also being adapted to align the first polarization with one of the slow principal axis and the fast principal axis and to align the second polarization with another one of the slow principal axis and the fast principal axis, so that the first polarization and the second polarization propagate at different group velocities through the birefringent wave-guide and are reflected, through coupling with the chirped grating, at different points along the birefringent wave-guide resulting in the first polarization undergoing a greater time delay in the birefringent wave-guide when compared to a time delay, in the birefringent wave-guide, of the second polarization.

15. An optical apparatus according to claim 14 wherein the birefringent wave-guide is a birefringent planar wave-guide.

16. An optical apparatus according to claim 14 wherein the birefringent wave-guide is a PM fiber.

17. An optical apparatus according to claim 14 wherein the chirped grating is one of a positive chirped grating and a negative chirped grating.

18. An optical apparatus according to claim 14 wherein the chirped grating has one of a linear spatial period, a non-linear spatial period and a quadratic spatial period.

19. An optical apparatus according to claim 14 comprising control means for tuning a total DGD, Δτ₁=Δτ+Δτ′, of the optical signal at an output, wherein Δτ′ is a DGD introduced in the birefringent wave-guide.

20. An optical apparatus according to claim 14 wherein the birefringent wave-guide is adapted to perform PMDC and CDC (Chromatic Dispersion Compensation) of a dispersive optical signal having wavelengths, λⱼ, and an average DGD, <Δτ>.

21. An optical apparatus according to claim 14 comprising:
a piezo-electric device, in which the birefringent wave-guide is embedded, adapted to control a spatial period, Λ, of the chirped grating;
an optical tap, at an output of the optical circulator, adapted to redirect a minor portion of the optical signal; and
a control circuit connected to the optical tap, the piezo-electric device and the PC, wherein the control circuit is adapted to receive the minor portion of the optical signal, detect a polarization state of the minor portion of the optical signal and detect a total DGD, Δτ₁=Δτ+Δτ′, of the first and second polarizations from the minor portion of the optical signal, wherein Δτ′ is a DGD introduced in the birefringent wave-guide, the control circuit also being adapted to provide instructions to the piezo-electric device for stretching the birefringent wave-guide, based on the total DGD, Δτ₁, and to provide instructions to the PC for tuning an alignment of the first and second polarizations with a respective one of the slow and fast principal axes of the birefringent wave-guide, based on the polarization state.

22. An optical Apparatus according to claim 14 comprising:
one or more heaters, in which the birefringent wave-guide is embedded, adapted to control effective indexes of refraction, n_{s,eff}, n_{f,eff}, of the slow and fast principal axes, respectively, of the birefringent wave-guide;
an optical tap, at an output of the optical circulator, adapted to redirect a minor portion of the optical signal; and
a control circuit connected to the optical tap, the piezo-electric device and the PC, wherein the control circuit is adapted to receive the minor portion of the optical signal, detect a polarization state of the minor portion of the optical signal and detect a total DGD, Δτ₁=Δτ+Δτ′, of the first and second polarizations from the minor portion of the optical signal, wherein Δτ′ is a DGD introduced in the birefringent wave-guide, the control circuit also being adapted to provide instructions to the one or more heaters for tuning the effective indexes of refraction, n_{s,eff}, n_{f,eff}, based on the total DGD, Δτ₁, and to provide instructions to the PC for tuning an alignment of the first and second polarizations with a respective one of the slow and fast principal axes of the birefringent wave-guide, based on the polarization state.

23. An optical apparatus according to claim 14 comprising an another wave-guide connecting the PC with the optical circulator.

24. An optical apparatus according to claim 14 wherein the optical circulator is a 3-port optical circulator.

25. An optical apparatus according to claim 14 adapted to perform PMDC and CDC of a dispersive optical signal having wavelengths, λⱼ, the apparatus comprising an optical wave-guide having a chirped grating connected to the optical circulator, the optical wave-guide being adapted to receive the dispersive optical signal and reflect the wavelengths, λⱼ, at different points along the optical wave-guide in a manner that the wavelengths, λⱼ, emerge from the optical wave-guide in synchronization.

26. An optical apparatus according to claim 25 wherein the optical wave-guide is an optical fiber.

27. An optical. apparatus according to claim 25 wherein the optical circulator is a 4-port optical circulator.

28. An optical apparatus according to claim 25 comprising control means for tuning an total average DGD, <Δτ₁>=<Δτ>+<Δτ′>, of the dispersive optical signal detected at an output, wherein <Δτ′> is a DGD introduced in the birefringent wave-guide.

29. An optical apparatus according to claim 25 comprising control means for tuning a dispersion of the dispersive optical signal detected at an output.

30. An optical apparatus according to claim 25 comprising:
a piezo-electric device, in which the optical wave-guide is embedded, adapted to control a spatial period, Λ′, of the chirped grating of the optical wave-guide;
an optical tap, at an output of the optical circulator, adapted to redirect a minor portion of the dispersive optical signal; and
a control circuit connected to the optical tap and the piezo-electric device, wherein the control circuit is adapted to receive the minor portion of the dispersive optical signal, detect a dispersion of the minor portion of the dispersive optical signal and provide instructions to the piezo-electric device for stretching the optical wave-guide, based on the dispersion of the minor portion of the dispersive optical signal.

31. An optical apparatus according to claim 25 comprising:
one or more heaters, in which the optical wave-guide is embedded, adapted to control an effective index of refraction, n′_{eff}, of the optical wave-guide;
an optical tap, at an output of the optical circulator, adapted to redirect a minor portion of the dispersive optical signal; and
a control circuit connected to the optical tap and the piezo-electric device, wherein the control circuit is adapted to receive the minor portion of the dispersive optical signal, detect a dispersion of the minor portion of the dispersive optical signal and to provide instructions to the one or more heaters for tuning the effective index of refraction, n′_{eff}, based on the dispersion of the minor portion of the dispersive optical signal.

32. An optical apparatus according to claim 25 comprising two optical wave-guides each having a chirped grating wherein one of the two optical wave-guides has a positive chirped grating and another one of the two optical wave-guides has negative chirped grating, the two optical wave-guides being connected to the optical circulator and being adapted to collectively perform CDC and prevent introduction of second order chromatic dispersion effects during CDC.

33. An integrated chip comprising the optical apparatus of claim 14 wherein the birefringent wave-guide, the optical circulator and the PC are implemented on the microchip.

34. An optical transmission system comprising an optical apparatus according to claim 14.

35. A method of performing PMDC upon an optical signal having a first polarization and a second polarization, wherein the second polarization lags the first polarization with a DGD, Δτ; the method comprising:
aligning the first polarization with one of a slow principal axis and a fast principal axis of a birefringent waveguide having a chirped grating and aligning the second polarization with another one of the slow principal axis and the fast principal axis; and
propagating the first polarization and the second polarization through the birefringent waveguide at different group velocities and reflecting the first polarization and the second polarization at different points along the birefringent waveguide;
wherein the aligning the first polarization and the aligning the second polarization are performed in a manner that the first polarization undergoes a greater time delay in the birefringent waveguide when compared to a time delay, in the birefringent waveguide, of the second polarization.

36. A method according to claim 35 comprising re-directing the optical signal to an output when the optical signal emerges from the birefringent wave-guide after being reflected.

37. A method according to claim 36 comprising:
measuring a polarization state of a minor portion of the optical signal at the output; and
tuning an alignment of the first polarization and the second polarization with a respective one of the slow principal axis and the fast principal axis based on the polarization state.

38. A method according to claim 36 comprising;
measuring a total DGD, Δτ₁=Δτ+Δτ′, between the first polarization and the second polarization, at the output, wherein Δτ′ is a DGD introduced in the birefringent wave-guide; and
tuning a spatial period, Λ, of the chirped grating, based on the total DGD, Δτ₁, by applying a tensile force upon the birefringent wave-guide to stretch the birefringent wave-guide and reduce the total OGD, Δτ₁.

39. A method ac(cording to claim 36 comprising:
measuring a total DGD, Δτ₁=Δτ+Δτ′, between the first polarization and the second polarization, at the output, wherein Δτ′ is a DGD introduced in the birefringent wave-guide; and
applying heat to the birefringent wave-guide to tune effective indexes of refraction, n_{s,eff}, n_{f,eff}, of the slow and fast principal axes, respectively, for reducing the total DGD, Δτ₁.

40. A method of performing PMDC and CDC comprising the method of claim 35, wherein the optical signal is a dispersive optical signal having wavelengths, λⱼ, and wherein after the propagating the first polarization and the second polarization through the birefringent wave-guide at different group velocities and reflecting the first polarization and the second polarization at different points along the birefringent wave-guide, the method comprising:
propagating the dispersive optical signal, and reflecting the wavelengths, λⱼ, at different points along an optical wave-guide in a manner that the wavelengths, λⱼ, emerge from the optical wave-guide in synchronization after being reflected.

41. A method according to claim 40 comprising re-directing the dispersive optical signal to an output when it emerges from the optical wave-guide.

42. A method according to claim 41 comprising:
measuring the dispersion of the dispersive optical signal at the output; and
tuning a spatial period, Λ′, of the chirped grating of the optical wave-guide, based on the dispersion, by applying a tensile force upon the optical wave-guide to stretch the optical wave-guide.

43. A method according to claim 41 comprising:
measuring the dispersion of the dispersive optical signal at the output.; and
applying heat to the optical wave-guide, based on the dispersion, to tune an effective index of refraction n′_{eff} of the optical wave-guide and reduce the dispersion.
